(19) United States
(12) Patent Application Publication
(10) Pub. No.: US 2007/0140943 A1
(43) Pub. Date: Jun. 21, 2007

(54) Sorbent composition to reduce emissions from the burning of carbonaceous fuels

(76) Inventor: Douglas C. Comrie, Stow, OH (US)

Correspondence Address: HARNESS, DICKEY & PIERCE, P.L.C., P.O. BOX 828, BLOOMFIELD HILLS, MI, 48303, US

(21) Appl. No.: 11/642,728

(22) Filed: Dec. 20, 2006

Related U.S. Application Data
(60) Provisional application No. 60/752,431, filed on Dec. 21, 2005.

(51) Int. Cl. A23J 7/00; B01D 53/52

(52) U.S. Cl. 423/242.1; 252/1

(57) ABSTRACT

Sulfur emissions from combustion of coal and other fuels are reduced by using sugar beet lime as a sorbent during the coal burning process. In various embodiments, the sugar beet lime is added onto the coal before combustion, along with the coal into the furnace, is injected directly into the fire coal, or is added into the flue gases downstream of the furnace. The relatively high calcium content of the sugar beet lime leads to efficient sulfur capture at suitably low treat levels. Excess ash is avoided in the process.

### CROSS-REFERENCE TO RELATED APPLICATIONS

This application claims the benefit of U.S. Provisional Application No. 60/752,431, filed on Dec. 21, 2005. The disclosure of the above application is incorporated herein by reference.

### INTRODUCTION

The present invention relates to processes and compositions for decreasing emissions of sulfur gases upon combustion of carbonaceous materials. In particular, sorbent compositions are added to coal to capture sulfur in the ash and prevent release of sulfur oxides into the atmosphere.

Cost effective energy sources necessary for sustaining economic growth and national well-being are becoming more difficult to identify and develop. Increasing costs of fuels such as oil, gas and propane have led to an extensive examination of other available energy sources. Two of the most cost effective sources of energy are nuclear power and coal power. Given public concerns with nuclear energy and its long-term disposal challenges, more emphasis is being placed on coal-generated power.

Significant coal resources exist in the United States and elsewhere. According to some estimates, known reserves are capable of meeting large portions of our energy needs into the next two centuries. In the United States, low BTU value coal is found in the Powder River Basin of Wyoming/Montana, lignite deposits in the north central region (North and South Dakota), sub-bituminous deposits of the East Pittsburgh seam in Pennsylvania, Ohio and West Virginia, and bituminous coal is found in the Illinois Basin. Except for the Powder River Basin coals, the United States coals tend to be characterized as having a high sulfur content. Although low sulfur coal can be shipped to other locations to provide a relatively clean burning fuel, it is more cost effective for utilities to bum locally produced coal. In most parts of the world this means burning a higher sulfur coal to satisfy society's energy needs.

The burning of high sulfur coal releases a significant amount of sulfur-containing gases, which can cause acid rain and other harmful effects if allowed to escape from the coal burning facility. When coal burns, mercury vapor can also be released into the atmosphere. Utilities and other coal consumers are constantly striving to reduce or eliminate the amount of emissions by power plants and coal powered boilers, in order to protect the environment and the health of its workers and customers. One effective strategy involves retrofitting older coal burning facilities with wet scrubbers for sulfur capture. These facilities are typically large in size and consume up to 5% of the energy generated by the plant. Although widely used, their cost is becoming almost prohibitively expensive, which leads to rate hikes that must be borne ultimately by the consumer or rate payer.

An alternative to wet scrubbing for removal of sulfur is the application of sulfur sorbing and stabilizing materials to the coal. Much work has been done in this area due to its ease of application and elimination of high capital costs for equipment as needed in wet scrubbing operations. Application of sulfur sorbent directly to the coal has the advantage of a long retention time with the furnace gases thus allowing for greater sulfur capture.

U.S. Pat. No. 4,824,441 by Kindig discusses several methods that have been tried in attempting to improve sulfur capture. Kelly, et al., concluded (first joint symposium on Dry SO₂ and simultaneous SO₂/NOₓ Control Technologies, EPA 600/9-85-020a, Paper no. 14, Jul. 1985) that sulfur sorbents should be injected downstream to avoid high peak temperatures in the combustion zone. It was also suggested that the residence time of calcium-based sorbents should be maximized in the 1800-2250° F. zone of the furnace. Work conducted by Dykema (U.S. Pat. No. 4,807,542) suggests the use of silicon to help optimize sulfur capture when combined with CaO as a remediation agent. Steinberg in U.S. Pat. No. 4,602,918 and 4,555,392 has suggested the use of Portland cement as a sorbent for coal.

As these references indicate, there is a need for cost effective remediation of sulfur, nitrogen, and chlorine resulting from the combustion of coal. More efficient and less costly removal techniques are still needed in order to effectively develop and utilize high sulfur coal resources.

### SUMMARY OF THE INVENTION

Harmful emissions from combustion of carbonaceous fuels are reduced by using a sorbent during the coal burning process. In various embodiments, a sorbent composition comprising sugar beet lime is added onto coal before combustion, along with the coal into the furnace, directly into the fire ball by injection, or is added into the flue gases downstream of the furnace. The relatively high calcium content of the sugar beet lime leads to efficient sulfur capture at suitable treatment levels. Excess ash is avoided in the process.

In another embodiment, use of sugar beet lime as a sulfur sorbent allows operation of a coal burning facility by applying the sorbent on to the coal, pulverizing the coal and feeding the coal into the furnace. Sulfur emissions in the flue gases are monitored and the rate or amount of addition of sugar beet lime onto the coal is adjusted to keep the sulfur emissions below a desired level.

Further areas of applicability of the present invention will become apparent from the detailed description provided hereinafter.

### DETAILED DESCRIPTION

In one embodiment, the invention provides a method for reducing the sulfur content of gases produced from the combustion of sulfur-containing fuels such as coal in a coal burning system. The method involves adding a sorbent composition containing sugar beet lime into the coal burning system during combustion. In various embodiments, the sugar beet lime is added onto the coal before the treated coal is delivered to the furnace for combustion. In some embodiments, the sorbent composition is added directly onto pulverized coal. Optionally or additionally, sugar beet lime is injected into the furnace during combustion or is injected into the convective pathways containing flue gases downstream of the furnace, preferably in a zone where the temperature is at least 500° C. and more preferably at least 800° C. In one embodiment, the temperature is from 1500° F. to 2700° F. (about 816° C. to 1482° C.).

In another embodiment, a combustible material is provided that comprises a major amount of coal or other sulfur-containing carbonaceous material and a minor amount, for example about 0.1% to about 10% by weight, of a sorbent composition comprising sugar beet lime. In various embodiments, the combustible material contains 0.1% to 10% by weight of sugar beet lime. In a preferred embodiment, the coal is provided in the form of particles where at least 50% by weight of the particles are smaller than 75 μm (200 mesh). In one embodiment, the composition is prepared by mixing the sorbent with the coal and pulverizing the mixture to achieve the noted size distribution. Advantageously, the composition is prepared in batch or continuously in a coal burning facility, whereby the sorbent composition is mixed with raw coal and the resulting mixture is pulverized prior to delivery to the coal burning furnace. In a preferred embodiment, the composition contains about from 1% to about 6% by weight of the sorbent composition.

In another embodiment, the invention provides a method for burning sulfur-bearing coal with reduced emissions of sulfur. The method comprises combining coal and a sorbent composition containing sugar beet lime to form a coal mixture containing from 0.1% to 10% by weight of sugar beet lime. The coal mixture is then preferably pulverized and delivered into the furnace of a coal burning facility. The pulverized coal mixture is then combusted in the furnace. The sulfur content of the flue gas resulting from the combustion is reduced in comparison to flue gas resulting from the burning of coal without the sugar beet lime. In various embodiments, the coal mixture comprises 0.1% to 10% by weight, 0.1% to 6% by weight, from 0.5% to 5% by weight, or from 1% to 5% by weight of the sugar beet lime. Preferably, the sugar beet lime is provided in the coal mixture in an amount sufficient to provide at least one mole of calcium per mole of sulfur in the coal.

In another embodiment, the invention provides a method of operating a coal burning facility. The method involves combusting a sulfur-containing coal. During the combustion, that is while combustion is occurring in the furnace of the coal burning facility, sugar beet lime is added as a sulfur sorbent into the system at an addition rate of 0.1% to 10%, based on the rate of consumption of the coal during combustion. During combustion, the sulfur content of flue gases downstream of the furnace are measured. The measured sulfur content of the flue gases is compared to a target sulfur content that is desired to be achieved for environmental, safety, or other reasons. If the measured sulfur content in the flue gases is above the target, the rate of addition of the sugar beet lime into the coal burning system is adjusted accordingly. If the measured sulfur content is at or below target, the method includes the step of leaving the addition rate of the sugar beet lime into the system unchanged or reducing it.

In various embodiments, sugar beet lime is added to raw coal or to pulverized coal. The sugar beet lime is added into the coal burning facility directly at the furnace (co-combustion), onto the coal before combustion (pre-combustion), or into the convective pathways downstream of the furnace (post-combustion), the latter preferably in a zone where the temperature is from 1500° F. to 2700° F. (about 816° C. to 1482° C.).

Coal is a preferred carbonaceous fuel for use in the invention. Coal suitable for use in the invention includes bituminous coals, anthracite coals, and lignite coals. Other carbonaceous fuels include, without limitation, various types of fuel oils, coal oil mixtures, coal oil water mixtures, and coal water mixtures. Other suitable carbonaceous fuels include municipal solid waste, sewage sludge industrial waste, medical waste, waste from wastewater treatment plants, and waste tires. When the carbonaceous fuel is other than a particulate coal or other fuel as described, the method of addition of the sorbent described above is adapted for use with the liquid fuels according to principles known in the art.

Carbonaceous fuel for use in the invention is used as supplied, or is prepared for treatment with sorbent compositions of the invention. In a preferred embodiment, coal is ground or pulverized prior to application of the sorbent composition. The powder sorbent compositions of the invention are generally applied to the particulate coal directly. In a preferred embodiment, the particulate coal and the solid sorbent compositions are blended with one another in mixers or similar devices.

Systems and facilities that burn carbonaceous fuels containing sulfur will be described with particular attention to the example of a coal burning facility such as used by electrical utilities. Such facilities generally have a feeding mechanism to deliver coal to a furnace where the coal is burned. The feeding mechanism can be any device or apparatus suitable for use. Non-limiting examples include conveyer systems, screw extrusion systems, and the like. In various embodiments, pulverized coal is delivered by air conveyance means such as blowers. In operation, a sulfur-containing fuel such as coal is fed into the furnace at a rate suitable to achieve the output desired from the furnace. Generally, the heat output from the furnace is captured to boil water for steam to provide direct heat, or else the steam is used to turn turbines that eventually result in the operation of generators to produce electricity.

In a typical coal burning facility, raw coal arrives in railcars and is delivered onto a receiving belt, which leads the coal into a pug mill. After the pug mill, the coal is discharged to a feed belt and deposited in a coal storage area. Under the coal storage area there is typically a grate and bin area; from there a belt transports the coal to an open stockpile area, sometimes called a bunker. From the bunker, the coal is delivered by belt or other means to a pulverizer. From the pulverizer the pulverized coal is delivered to the furnace for combustion. Sorbent compositions according to the invention can be added in various embodiments to the raw coal, in the pug mill, on the receiving belt or feed belt, in the coal storage area, in the pulverizer before or during pulverization, and/or while being transported from the pulverizer to the furnace for combustion. Conveniently, the sorbents are added to the coal during processes that mix the coal such as the in the pug mill or in the pulverizer. In a preferred embodiment, the sorbents are added onto the coal in the pulverizers.

The effectiveness of combustion in a furnace is a function of the reactivity and the particle size distribution of the coal. Processing of coal to reduce particle size increases surface area per particle, and proportionately improves combustion efficiency. Pulverizers are commonly used for crushing large coal pieces into small particles, typically through use of methods such as dynamic impact, attrition against screen bars, shearing between hard surfaces, compression crushing, and combinations thereof. Pulverizers produce powdered or pulverized coal, which is then injected into the furnace for combustion. Such coal is characterized by particles with a size distribution. Preferably, pulverized coal contains at least 10% by weight of particles smaller than 75 μm (200 mesh). In various embodiments, the pulverized coal has at least 20% by weight and preferably at least 50% by weight of particles that are of a diameter to pass through a 200 mesh screen. In a typical embodiment, the pulverized coal has 78% by weight or more by weight of its particles below 75 μm. In various embodiments, sorbent compositions comprising sugar beet lime are applied onto pulverized coal or onto coal prior to pulverization.

In addition to use of sorbent with coal upstream of the furnace, as described in the paragraph above, the sorbents in various embodiments are added into the furnace during combustion and/or into plant sections downstream of the furnace where the flue gases preferably have a temperature of above 500° C., more preferably above 800° C.

During operation, coal is fed into the furnace and burned in the presence of oxygen. For high value (high Btu) carbonaceous fuels such as coal, typical flame temperatures in the combustion temperature are on the order of 2700° F. (about 1480° C.) to about 3000° F. (about 1640° C.). Carbonaceous fuels, or mixtures of carbonaceous fuels containing less energy content (e.g., liquid hydrocarbons, wood, wood chips, scrap rubber, and other wastes) tend to burn at lower temperatures, depending also on the water content of the fuel. Downstream of the furnace or boiler where the fed fuel is combusted, the facility provides convective pathways for the combustion gases, which for convenience are sometimes referred to as flue gases. Hot combustion gases and air move by convection away from the flame through the convective pathway in a downstream direction (i.e., away from the fireball). The convective pathway of the facility contains a number of zones characterized by the temperature of the gases and combustion products in each zone. Generally, the temperature of the combustion gas falls as it moves in a direction downstream from the fireball. The combustion gases contain carbon dioxide, various undesirable gases containing sulfur, and mercury vapor. The convective pathways are also filled with a variety of ash which is swept along with the high temperature gases. To remove the ash before emission into the atmosphere, particulate removal systems are used. A variety of such removal systems, such as electrostatic precipitators and a bag house, are generally disposed in the convective pathway. In addition, chemical scrubbers can be positioned in the convective pathway. Additionally, there may be provided various instruments to monitor components of the gas, such as sulfur oxides.

From the furnace, where the coal typically burns at a temperature of approximately 2700° F. to 3000° F. (about 1480° C. to 1650° C.), the fly ash and combustion gases move downstream in the convective pathway to zones of ever decreasing temperature. Immediately downstream of the fireball is a zone with temperature less that 2700° F. Further downstream, a point is reached where the temperature has cooled to about 1500° F. Between the two points is a zone having a temperature from about 1500° F. to about 2700° F. Further downstream, a zone of less than 1500° F. may be reached, and so on. Further along in the convective pathway, the gases and fly ash pass through lower temperature zones until the bag house or electrostatic precipitator is reached, which typically has a temperature of about 300° F. before the gases are emitted up the stack

In various aspects, the invention involves addition of sorbent independently and in combination onto coal (pre-combustion), into the furnace during combustion (co-combustion), and/or into convective pathways downstream of the furnace (post-combustion). In various embodiments, a combination of pre-combustion, co-combustion, and post-combustion additions is carried out.

When a sulfur sorbent composition is inserted or injected into the convective pathway of the coal burning facility to reduce the sulfur levels, it is preferably added into a zone of the convective pathway downstream of the fireball (caused by combustion of the coal), which zone has a temperature above about 500° C., preferably above about 800° C., and most preferably above about 1500° F. (815° C.), and less than the fireball temperature of 2700° F. to 3000° F. (1482° C. to 1649° C.). In various embodiments, the temperature in the zone of sorbent addition is above about 1700° F. (927° C.). The zone preferably has a temperature below about 2700° F. (approximately 1482° F.). In various embodiments, the injection zone has a temperature below 2600° F., below about 2500° F. or below about 2400° F. In non-limiting examples, the injection temperature is from 1700° F. to 2300° F., from 1700° F. to 2200° F., or from about 1500° F. to about 2200° F. In various embodiments, the rate of addition of sorbent into the convective pathway is varied depending on the results of sulfur monitoring as described above with respect to pre-combustion addition of sorbent.

When the flame temperature is lower than 2700-3000° F., similar considerations hold. Injection of sorbent containing sugar beet lime is preferably made into a zone of the convective pathway where the temperature is above 500° C. In various embodiments at lower flame temperatures, reduction of mercury is observed upon use of the sorbents. Such lower temperatures include 1000° F.-2600° F., preferably 1000° F.-2000° F. and more preferably 1000° F.-1500° F.

The sulfur sorbent compositions of the invention contain sugar beet lime and optionally other components, including other sulfur sorbents (i.e., compounds that contribute to reduction of sulfur). The sulfur sorbent composition preferably contains calcium at a level at least equal, on a molar basis, to the sulfur level present in the coal being burned. As a general principle, the calcium level is preferably no more than about three times, on a molar basis, the level of sulfur. The 1:1 Ca:S level is preferred for efficient sulfur removal, and the upper 3:1 ratio is preferred to avoid production of excess ash from the combustion process. Treatment levels outside the preferred ranges are also part of the invention. Suitable sulfur sorbents in addition to sugar beet lime are described, for example, in co-owned provisional application 60/583,420, filed Jun. 28, 2004, the disclosure of which is incorporated by reference.

Exemplary sulfur sorbents in addition to sugar beet lime include basic powders containing calcium salts such as calcium oxide, hydroxide, and carbonate. Other basic powders include Portland cement, cement kiln dust, and lime kiln dust.

In various embodiments, desired treat levels of silica and/or alumina are above those provided by adding materials such as Portland cement, cement kiln dust, lime kiln dust, and/or sugar beet lime. Accordingly, it is possible to supplement such materials with aluminosilicate materials, such as without limitation clays (e.g. montmorillonite, kaolins, and the like) where needed to provide preferred silica and alumina levels. In various embodiments, supplemental aluminosilicate materials make up at least about 2%, and preferably at least about 5% by weight of the various sorbent components added into the coal burning system. In general, there is no upper limit from a technical point of view as long as adequate levels of calcium are maintained. However, from a cost standpoint, it is normally desirable to limit the proportion of more expensive aluminosilicate materials. Thus, the sorbent components preferably comprise from about 2 to 50%, preferably 2 to 20%, and more preferably, about 2 to 10% by weight aluminosilicate material such as the exemplary clays. A non-limiting example of a sorbent is about 93% by weight of a blend of CKD and LKD (for example, a 50:50 blend or mixture) and about 7% by weight of aluminosilicate clay.

In various embodiments, an alkaline powder sorbent composition contains one or more calcium-containing powders such as Portland cement, cement kiln dust, lime kiln dust, various slags, and sugar beet lime, along with an aluminosilicate clay such as, without limitation, montmorillonite or kaolin. The sorbent composition preferably contains sufficient SiO₂ and Al₂O₃ to form a refractory-like mixture with calcium sulfate produced by combustion of the sulfur-containing coal in the presence of the CaO sorbent component such that the calcium sulfate is handled by the particle control system; and to form a refractory mixture with mercury and other heavy metals so that the mercury and other heavy metals are not leached from the ash under acidic conditions. In preferred embodiments, the calcium containing powder sorbent contains by weight a minimum of 2% silica and 2% alumina, preferably a minimum of 5% silica and 5% alumina. Preferably, the alumina level is higher than that found in Portland cement, that is to say higher than about 5% by weight, preferably higher than about 6% by weight, based on Al₂O₃.

In various embodiments, the sorbent components of the alkaline powder sorbent composition work together with optional added halogen (such as bromine) compound or compounds to capture chloride as well as mercury, lead, arsenic, and other heavy metals in the ash, render the heavy metals non-leaching under acidic conditions, and improve the cementitious nature of the ash produced. As a result, emissions of harmful elements are mitigated, reduced, or eliminated, and a valuable cementitious material is produced as a by-product of coal burning.

Suitable aluminosilicate materials include a wide variety of inorganic minerals and materials. For example, a number of minerals, natural materials, and synthetic materials contain silicon and aluminum associated with an oxy environment along with optional other cations such as, without limitation, Na, K, Be, Mg, Ca, Zr, V, Zn, Fe, Mn, and/or other anions, such as hydroxide, sulfate, chloride, carbonate, along with optional waters of hydration. Such natural and synthetic materials are referred to herein as aluminosilicate materials and are exemplified in a non-limiting way by the clays noted above.

In aluminosilicate materials, the silicon tends to be present as tetrahedra, while the aluminum is present as tetrahedra, octahedra, or a combination of both. Chains or networks of aluminosilicate are built up in such materials by the sharing of 1, 2, or 3 oxygen atoms between silicon and aluminum tetrahedra or octahedra. Such minerals go by a variety of names, such as silica, alumina, aluminosilicates, geopolymer, silicates, and aluminates. However presented, compounds containing aluminum and/or silicon tend to produce silica and alumina upon exposure to high temperatures of combustion in the presence of oxygen

In one embodiment, aluminosilicate materials include polymorphs of SiO₂.Al₂O₃. For example, silliminate contains silica octahedra and alumina evenly divided between tetrahedra and octahedra. Kyanite is based on silica tetrahedra and alumina octahedra. Andalusite is another polymorph of SiO₂.Al₂O₃.

In other embodiments, chain silicates contribute silicon (as silica) and/or aluminum (as alumina) to the compositions of the invention. Chain silicates include without limitation pyroxene and pyroxenoid silicates made of infinite chains of SiO₄ tetrahedra linked by sharing oxygen atoms.

Other suitable aluminosilicate materials include sheet materials such as, without limitation, micas, clays, chrysotiles (such as asbestos), talc, soapstone, pyrophillite, and kaolinite. Such materials are characterized by having layer structures wherein silica and alumina octahedra and tetrahedra share two oxygen atoms. Layered aluminosilicates include clays such as chlorites, glauconite, illite, polygorskite, pyrophillite, sauconite, vermiculite, kaolinite, calcium montmorillonite, sodium montmorillonite, and bentonite. Other examples include micas and talc.

Suitable aluminosilicate materials also include synthetic and natural zeolites, such as without limitation the analcime, sodalite, chabazite, natrolite, phillipsite, and mordenite groups. Other zeolite minerals include heulandite, brewsterite, epistilbite, stilbite, yagawaralite, laumontite, ferrierite, paulingite, and clinoptilolite. The zeolites are minerals or synthetic materials characterized by an aluminosilicate tetrahedral framework, ion exchangeable “large cations” (such as Na, K, Ca, Ba, and Sr) and loosely held water molecules.

In other embodiments, framework or 3D silicates, aluminates, and aluminosilicates are used. Framework aluminosilicates are characterized by a structure where SiO₄ tetrahedra, AlO₄ tetrahedra, and/or AlO₆ octahedra are linked in three dimensions. Non-limiting examples of framework silicates containing both silica and alumina include feldspars such as albite, anorthite, andesine, bytownite, labradorite, microcline, sanidine, and orthoclase.

In various embodiments, the sulfur sorbent also contains a suitable level of magnesium in the form of MgO, contributed for example by dolomite or as a component of Portland cement. In a non-limiting example, a sulfur sorbent used together with sugar beet lime contains 60% to 71% CaO, 12% to 15% SiO₂, 4% to 18% Al₂O₃, 1% to 4% Fe₂O₃, 0.5% to 1.5% MgO, and 0.1% to 0.5% NaO.

In various embodiments, sulfur emissions from the coal burning facility are monitored. Depending on the level of sulfur in the flue gas prior to emission from the plant, the amount of sorbent composition added onto the fuel pre-, co-, and/or post-combustion is raised, lowered, or is maintained unchanged. In general, it is desirable to remove as high a level of sulfur as is possible. In typical embodiments, sulfur removal of 90% and greater are is achieved, based on the total amount of sulfur in the coal. This number refers to the sulfur removed from the flue gases so that sulfur is not released through the stack into the atmosphere. To minimize the amount of sorbent added into the coal burning process so as to reduce the overall amount of ash produced in the furnace, it is desirable in many embodiments to use the measurements of sulfur emissions to adjust the sorbent composition rate of addition to achieve the desired sulfur reduction without adding excess material into the system.

To control mercury emissions, in various embodiments mercury is monitored in the flue gas. A mercury sorbent composition containing a halogen compound is optionally used along with the sorbent composition that contains sugar beet lime. In various embodiments, the composition containing sugar beet lime also contains a halogen. According to the measured mercury level, the rate of sorbent addition is decreased, increased or maintained.

Sorbent compositions comprising a halogen compound contain one or more organic or inorganic compounds that contain a halogen. Halogens include chlorine, bromine, and iodine. Preferred halogens are bromine and iodine. The halogen compounds are sources of the halogens, especially of bromine and iodine. For bromine, sources of the halogen include various inorganic salts of bromine including bromides, bromates, and hypobromites. In various embodiments, organic bromine compounds are less preferred because of their cost or availability. However, organic sources of bromine containing a suitably high level of bromine are considered within the scope of the invention. Non-limiting examples of organic bromine compounds include methylene bromide, ethyl bromide, bromoform, and carbon tetrabromide. Non-limiting inorganic sources of iodine include hypoiodites, iodates, and iodides, with iodides being preferred. Organic iodine compounds can also be used.

When the halogen compound is an inorganic substituent, it is preferably a bromine or iodine containing salt of an alkaline earth element. Exemplary alkaline earth elements include beryllium, magnesium, and calcium. Of halogen compounds, particularly preferred are bromides and iodides of alkaline earth metals such as calcium. Alkali metal bromine and iodine compounds such as bromides and iodides are effective in reducing mercury emissions. But in some embodiments, they are less preferred as they tend to cause corrosion on the boiler tubes and other steel surfaces and/or contribute to tube degradation and/or firebrick degradation. In various embodiments, it has been found desirable to avoid potassium salts of the halogens, in order to avoid problems in the furnace.

In various embodiments, sorbent compositions containing halogen are provided in the form of a liquid or of a solid composition. In various embodiments, the halogen-containing composition is applied to the coal before combustion, is added to the furnace during combustion, and/or is applied into flue gases downstream of the furnace. When the halogen composition is a solid, it can further contain the calcium, silica, and alumina components described herein as the powder sorbent. Alternatively, a solid halogen composition is applied onto the coal and/or elsewhere into the combustion system separately from the sorbent components comprising calcium, silica, and alumina. When it is a liquid composition it is generally applied separately.

In various embodiments, liquid mercury sorbent comprises a solution containing 5% to 60% by weight of a soluble bromine or iodine containing salt. Non-limiting examples of preferred bromine and iodine salts include calcium bromide and calcium iodide. In various embodiments, liquid sorbents contain 5% to 60% by weight of calcium bromide and/or calcium iodide. For efficiency of addition to the coal prior to combustion, in various embodiments it is preferred to add mercury sorbents having as high level of bromine or iodine compound as is feasible. In a non-limiting embodiment, the liquid sorbent contains 50% or more by weight of the halogen compound, such as calcium bromide or calcium iodide.

To further illustrate, one embodiment of the present invention involves the addition of liquid mercury sorbent directly to raw or crushed coal prior to combustion. For example, mercury sorbent is added to the coal in the coal feeders. Addition of liquid mercury sorbent ranges from 0.01% to 5%. In various embodiments, treatment is at less than 5%, less than 4%, less than 3%, or less than 2%, where all percentages are based on the amount of coal being treated or on the rate of coal consumption by combustion. Higher treatment levels are possible, but tend to waste material, as no further benefit is achieved. Preferred treatment levels are from 0.025% to 2.5% by weight on a wet basis. The amount of solid bromide or iodide salt added by way of the liquid sorbent is of course reduced by its weight fraction in the sorbent. In an illustrative embodiment, addition of bromide or iodide compound is at a low level such as from 0.01% to 1% by weight based on the solid. When a 50% by weight solution is used, the sorbent is then added at a rate of 0.02% to 2% to achieve the low levels of addition. For example, in a preferred embodiment, the coal is treated by a liquid sorbent at a rate of 0.02% to 1%, preferably 0.02% to 0.5% calculated assuming the calcium bromide is about 50% by weight of the sorbent. In a typical embodiment, approximately 1%, 0.5%, or 0.25% of liquid sorbent containing 50% calcium bromide is added onto the coal prior to combustion, the percentage being based on the weight of the coal. In a preferred embodiment, initial treatment is started at low levels (such as 0.01% to 0.1%) and is incrementally increased until a desired (low) level of mercury emissions is achieved, based on monitoring of emissions. Similar treatment levels of halogen are used when the halogen is added as a solid or in multi-component compositions with other components such as calcium, silica, alumina, iron oxide, and so on.

When used, liquid sorbent is sprayed, dripped, or otherwise delivered onto the coal or elsewhere into the coal burning system. In various embodiments, addition is made to the coal or other fuel at ambient conditions prior to entry of the fuel/sorbent composition into the furnace. For example, sorbent is added onto powdered coal prior to its injection into the furnace. Alternatively or in addition, liquid sorbent is added into the furnace during combustion and/or into the flue gases downstream of the furnace. Addition of the halogen containing mercury sorbent composition is often accompanied by a drop in the mercury levels measured in the flue gases within a minute or a few minutes; in various embodiments, the reduction of mercury is in addition to a reduction achieved by use of an alkaline powder sorbent based on calcium, silica, and alumina.

In another embodiment, the invention involves the addition of a halogen component (illustratively a calcium bromide solution) directly to the furnace during combustion. In another embodiment, the invention provides for an addition of a calcium bromide solution such as discussed above, into the gaseous stream downstream of the furnace in a zone characterized by a temperature in the range of 2700° F. to 1500° F., preferably 2200° F. to 1500° F. In various embodiments, treat levels of bromine compounds, such as calcium bromide are divided between co-, pre- and post-combustion addition in any proportion.

Sugar beet lime is an article of commerce and a by-product of production of sugar from sugar beets. At a processing plant, beet roots are first washed and then sliced into thin strips called cossettes. The cossettes, containing high levels of sucrose, are then subject to a hot water extraction, preferably using countercurrent flow methods. The liquid resulting is called raw juice. The cossettes or pulp from which the sucrose has been extracted is then pressed to remove liquid and the liquid is added to the raw juice.

The raw juice contains a variety of impurities that are to be removed before final production of sucrose. To remove impurities, the juice is mixed with milk of lime and subjected to treatment with carbon dioxide. The treatment precipitates a number of the impurities including various anions as well as proteins and other macromolecules. Carbon dioxide is used to precipitate the lime as calcium carbonate as well as the impurities. That is, some of the impurities are entrapped with the precipitating calcium carbonate and other impurities are absorbed onto the calcium carbonate. After settling, the solids form a mud from which, after a series of washings, the sugar beet lime is recovered.

Sugar beet lime is used as a sulfur sorbent on coal or other carbonaceous fuels. Treatment of the coal (or addition into the coal burning system at appropriate rates) is at a level effective to provide the desired reduction in sulfur emissions. Exemplary treatment levels are from about 0.1% to 10% by weight of a sorbent composition containing sugar beet lime and optionally other sulfur sorbents. Treatment at lower levels tends not be as effective as desired, while treatment at high levels tends to waste material. In non-limiting examples, a sulfur sorbent comprising sugar beet lime is used at levels of 1% to 10% by weight, 1% to 8% by weight, 1% to 6% by weight, and 2% to 5% by weight based on the total weight of the coal or other sulfur containing fuel to be burned. The treat level refers to the amount of solid sorbent composition added on to coal pre-combustion, or to the addition rate of sulfur sorbent in to a coal burning facility. Thus, continuous processes encompass addition of sorbent into the furnace or into the flue gases downstream of the furnace at addition rates of 0.1% to 10% of the consumption rate of coal based on the combustion.

In various aspects, the effectiveness of sugar beet lime as a sulfur sorbent for coal and other sulfur containing fuels is believed to be attributable to its high calcium content and/or its alkaline nature. In various embodiments, sugar beet lime is used together with other calcium containing materials to provide effective levels of calcium or other components to reduce sulfur and/or mercury emissions resulting from combustion of the fuel. Advantageously, the high calcium content of the sugar beet lime results in weight loadings of sorbent that do not produce excessive ash in the combustion process. The resulting ash, which is enriched in sulfur as a result of capture by the calcium in the sugar beet lime, can be disposed of by conventional methods and/or sold to various industries as industrial raw material.

The invention has been described with respect various enabling disclosure, but it is to be understood the invention is not limited to the disclosed embodiments. Variations and modifications that would occur to a person of skill in the art upon reading the disclosure are also within the scope of the inventions, which is defined in the appended claims. The disclosure is merely exemplary in nature and, thus, variations that do not depart from the gist of the invention are intended to be within the scope of the invention. Such variations are not to be regarded as a departure from the spirit and scope of the invention.

What is claimed is:

1. A method of reducing the sulfur content of gas emitted from a carbonaceous fuel burning system during combustion of a sulfur-containing carbonaceous fuel, the method comprising adding a sorbent composition comprising sugar beet lime into the system during combustion.

2. A method according to claim 1, wherein the sulfur-containing carbonaceous fuel comprises coal.

3. A method according to claim 2, comprising treating the coal by adding the sorbent composition at a level to deliver from 0.1% to 10% by weight of sugar beet lime based on the weight of the coal, delivering the treated coal into the furnace, and combusting the treated coal.

4. A method according to claim 3, wherein the sorbent composition is added onto pulverized coal.

5. A method according to claim 1, comprising injecting the sorbent composition into the furnace.

6. A method according to claim 1, comprising injecting the sorbent composition into a convective pathway downstream of the furnace.

7. A method according to claim 6, wherein the temperature of the flue gas at the point of injection is from 1700° F. to 2500° F.

8. A composition comprising a sulfur-containing carbonaceous fuel and 0.1% to 10% by weight of sugar beet lime.

9. A composition according to claim 8, wherein the sulfur-containing carbonaceous fuel comprises coal.

10. A composition according to claim 9, wherein the coal is in the form of particles wherein at least 10% by weight of the coal is in particles of 75 μm or smaller.

11. A composition according to claim 9, prepared by mixing sugar beet lime and coal and pulverizing the mixture.

12. A composition according to claim 9, comprising 1% to 6% by weight sugar beet lime.

13. A method for burning sulfur-bearing carbonaceous fuel with reduced emissions of sulfur, comprising:
combining sulfur-bearing carbonaceous fuel and a sorbent comprising sugar beet lime to form a mixture comprising 0.1% to 10% by weight sugar beet lime;
pulverizing the mixture;
delivering the pulverized mixture into the furnace of a carbonaceous fuel burning facility; and
combusting the pulverized mixture in the furnace.

14. A method according to claim 13, wherein the sulfur-bearing carbonaceous fuel comprises coal.

15. A method according to claim 14, wherein the mixture comprises 0.1% to 6% by weight sugar beet lime.

16. A method according to claim 14, wherein the mixture comprises 0.5% to 6% by weight sugar beet lime.

17. A method according to claim 14, wherein the mixture comprises 1% to 5% by weight sugar beet lime.

18. A method according to claim 14, wherein the coal mixture contains at least one mole of calcium per one mole of sulfur in the coal.

19. A method of operating a coal burning facility, comprising:
combusting a sulfur containing coal;
during combustion, adding sugar beet lime into the system at an addition rate of about 0.1% to 10% by weight, based on the rate of consumption of coal by combustion;
measuring the sulfur content of flue gases downstream of combustion;
comparing the measured sulfur content to a target sulfur content; and
if the measured sulfur content is above the target, increasing the rate of addition of the sugar beet lime.

20. A method according to claim 19, comprising adding a sorbent composition comprising sugar beet lime to raw coal.

21. A method according to claim 19, comprising adding a sorbent composition comprising sugar beet lime to pulverized coal.

22. A method according to claim 19, comprising adding a sorbent composition comprising sugar beet lime directly to the furnace of the coal burning facility.

23. A method according to claim 19, comprising adding a sorbent composition comprising sugar beet lime into a convective pathway downstream of the coal burning facility in a zone where the temperature of the flue gases is 1500° F. to 2700° F.

24. A method according to claim 19, comprising adding a sorbent composition comprising sugar beet lime onto the coal pre-combustion and combusting the coal/sugar beet lime mixture.

25. A method according to claim 24, wherein the coal/sugar beet lime mixture comprises 0.1% to 10% by weight of sugar beet lime.

26. A method according to claim 24, wherein sugar beet lime is present in the mixture at an amount to provide at least one mole of calcium per one mole of sulfur in the coal.
